(19) United States
(12) Patent Application Publication
(10) Pub. No.: US 2005/0024125 A1
(43) Pub. Date: Feb. 3, 2005

(54) Highly efficient, high current drive, multi-phase voltage multiplier

(76) Inventors: John L. McNitt, Fort Collins, CO (US); Russell E. Radke, Fort Collins, CO (US)

Correspondence Address: LSI LOGIC CORPORATION, 1621 BARBER LANE, MS: D-106, MILPITAS, CA, 95035, US

(21) Appl. No.: 10/632,300

(22) Filed: Aug. 1, 2003

(51) Int. Cl. G05F 3/02

(52) U.S. Cl. 327/536

(57) ABSTRACT

The highly efficient, high current drive, multi-phase voltage multiplier reduces the inefficiency due to the active level overlapping portion of the clock at high frequencies, reduces the inefficiency due to extremely large drive currents on the inverters supplying current to the multiplying capacitors C1(*) and C2(*), and increases the efficiency of the multiplier by allowing M-1 phases to charge the output at any given time and providing more time given to each capacitor to fully charge and discharge. The ripple on the output is much smaller than in a single dual phase multiplier. This multi-phase voltage multiplier supplies very large current to the load while remaining very efficient.

### FIELD OF THE INVENTION

The present invention generally relates to the field of integrated circuits, and particularly to a voltage doubling and voltage regulating integrated circuit.

### BACKGROUND OF THE INVENTION

Voltage multipliers are used in various applications where a device or circuit, such as an integrated circuit, requires a higher voltage than that provided by the power supply. The voltage multiplier can only supply up to a certain rated current that is less than the power supply maximum current. During each clock cycle, enough charge must be moved from the doubling capacitors to the load capacitors to support the maximum rated current for an entire clock cycle until the next pulse of charge is delivered to the load. To increase the amount of load current the multiplier can supply, the designer generally can either add capacitance or increase the clock frequency (thereby increasing the number of times per second the charge is deposited on the load). There are two problems associated with adding more capacitance in conventional voltage multiplier circuits. One problem is that the buffers needed to drive these capacitors become very large. As the charging capacitors increase in size, the power needed to supply them with ‘fast’ edges increases exponentially. The reason for this is the non-ideality of the inverters and their increasing ON resistance as the voltage at their outputs nears VDD or VSS. Therefore, increasing the capacitor size to increase output drive will begin to lower the multiplier's efficiency and, at some point, the inefficiency of the multiplier will limit the design. The second problem introduced by increasing capacitor size is that the switches needed to carry the charge to the output capacitor become very large since they must be in or near their triode region during normal operation. Increasing the frequency of the clock increases the current driving capabilities of the voltage multiplier to a certain point. Then, the efficiency of the multiplier begins to go down dramatically. One reason for this is that the clocks entering the multiplier must never be at a LOW level at the same time (i.e., the inactive or LOW level portions must be non-overlapping). This requirement means that at higher frequency operation, the active level overlap time becomes a much larger percentage of the clock period. Another reason the multiplier becomes less efficient as the frequency increases is that the ability for charge to actually transfer from the multiplying capacitors to the load capacitor diminishes as the time of transfer goes down. These fundamental problems limit voltage multipliers to low current applications and limit their overall usefulness.

Therefore, it would be desirable to provide a highly efficient high current voltage multiplier.

### SUMMARY OF THE INVENTION

Accordingly, the present invention is directed to a circuit and method for supplying voltage multiplication at an ‘effective’ high frequency of operation and with large current drive capabilities.

In a first aspect of the present invention, a high current, multi-phase voltage multiplier includes a multiple phase active level overlapping clock generator that generates a plurality of unique phase clocks. Each phase clock is paired with another phase clock such that the two phase clocks of a pair are never inactive at the same time. The phase clock pairs each activate a charging circuit that includes two pairs of voltage dividers and two charging capacitors. The voltage dividers are each formed of two switches (or other active or passive elements) tied together. Preferably, the two switches are an NMOS transistor and a PMOS transistor electrically connected through their respective drain terminals. The charging capacitors are driven by the multiple phase active level overlapping clock generator.

In a second aspect of the present invention, a method for multiplying a voltage involves setting a length of the phase clock period and setting a duty cycle that favors the active HIGH level. The phase clocks are paired such that at least one of the phase clocks is at the HIGH level. The phase clocks are used to charge and discharge capacitors that drive the voltage multiplication circuitry.

The circuit of the present invention solves the problems associated with high load current voltage multiplier circuits. The circuit reduces the inefficiency due to the active level overlapping portion of the clock at high frequencies. It reduces the inefficiency due to extremely large drive currents on the inverters supplying current to the multiplying capacitors C1(*) and C2(*). It increases the efficiency of the multiplier by allowing M-1 phases to charge the output at any given time and also increases the time given to each capcitor to fully charge and discharge. The multi-phase voltage multiplier has an added benefit that the ripple on the output is much smaller than in single phase multipliers. This multi-phase voltage multiplier is unique in that it can supply very large current to the load and remain very efficient.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 illustrates a preferred embodiment of the circuit of the present invention;

FIG. 2 illustrates an alternative embodiment of the circuit using diodes instead of PMOS transistors;

FIG. 3 illustrates an embodiment of a method of the present invention; and

FIG. 4 illustrates waveforms provided by the circuit of FIG. 1.

### DETAILED DESCRIPTION OF THE INVENTION

Reference will now be made in detail to the presently preferred embodiments of the invention, examples of which are illustrated in the accompanying drawings.

The present invention relates to a circuit and method for a high current, high frequency voltage multiplier. In the present invention, parallel circuit combinations perform a twice per phase clock charge pump and dump onto the voltage multiplier output line. Multiple parallel circuit combinations, each slightly out of phase with the others, ensure that the multiplier output continually has available a sufficient amount of charge for a driving current. Each parallel circuit combination includes two voltage dividers and two charging capacitors. The voltage dividers are formed from active or passive elements tied together: one end is fed through the power supply, the middle controls charging and discharging, and the other end provides the multiplied voltage.

The voltage multiplier of the present invention uses multiple clock phases to relieve the problems associated with conventional voltage multipliers. By using multiple, slower clock phases to provide charge to the output, several benefits are realized: the size of each multiplying capacitor is reduced, the time each multiplying capacitor has to discharge onto the load capacitor remains large, and the active level overlap time of the clocks becomes a lower percentage of the clock period. The buffers used to drive the multiplying capacitors can be reduced and the current needed to supply ‘fast’ edges to these clocks is reduced significantly. An added benefit of the present invention is that the amount of voltage ripple on the load decreases significantly from a design that uses larger capacitors or a higher frequency to create a higher drive current. Since only a portion of the charge is delivered to the load each phase during a much lengthened delivery (or, charge transfer) time, ripple is very small on the load. If there are M clock phases, at any given time, at least M-1 charging capacitors are supplying charge at the same time. The active level overlap time becomes a much smaller percentage of the overall period. Since the multiplier is not delivering charge when the clocks are both at a HIGH level, active level overlap time results in inefficiency. By using multiple clock phases, the percentage of time the clocks are overlapped at the active HIGH level is reduced as described by the relationship Tnol(mf)=Tnol(ck)/M, where M is the number of clock phases, Tnol(mf) is the percentage of time the dual phase clocks are active level overlapped in multiple dual phase clocks, and Tnol(ck) is the percentage of time the clocks are active level overlapped in a single dual phase clock pair. For example, if the efficiency due to active level overlapping clocks for the single dual phase clock is approximately 66%, meaning the single dual phase clocks are active level (i.e., HIGH level) overlapping ⅓ of the time, then by using two dual phase clock pairs, the efficiency due to active level overlapping clocks is now approximately 83% (clocks active level overlap ⅙ of the time) and, for four dual phase clock pairs, the efficiency would not be approximately 92% (clocks active level overlap 1/12 of the time). This shows the enormous advantage of using multiple dual phase clock pairs instead of a single dual phase clock pair.

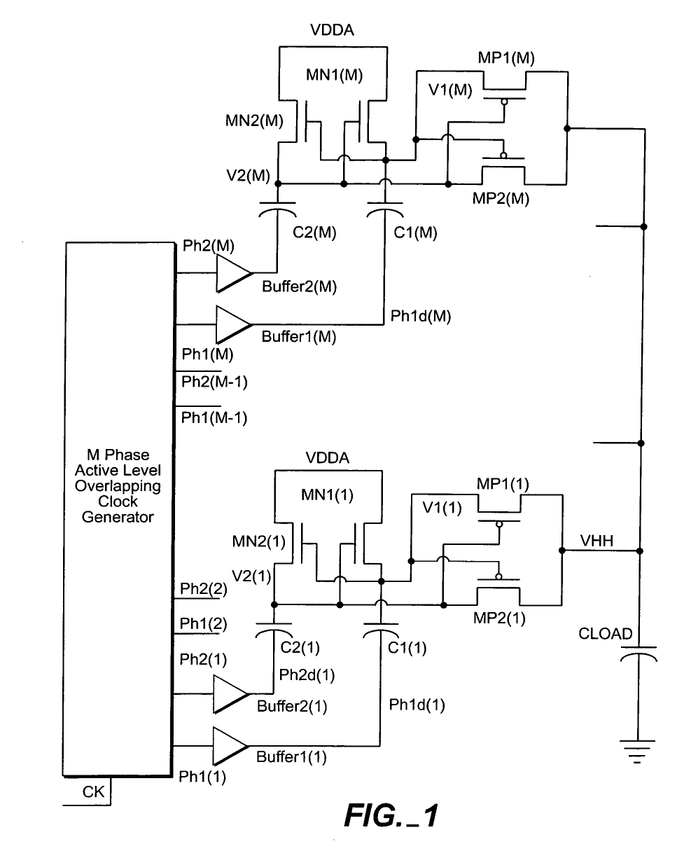

FIG. 1 illustrates a preferred embodiment of the circuit of the present invention. An M phase clock generator provides 2*M clocks or M pairs of active level overlapping phase clocks. The term “active level overlapping” refers to the simultaneous occurrence of the active HIGH portion of the two phase clocks of a dual phase clock pair. If the two phase clocks of a pair were to overlap their inactive low portions, power would be drained from the doubled voltage output VHH. In FIG. 1, each phase clock Ph1(*), Ph2(*) is buffered by a buffer Buffer1 (*), Buffer2 (*). The buffer may be an inverter, a pair of inverters, or other circuitry that isolates the clock generator from the voltage multiplier circuitry. Each buffer drives a charging capacitor C1(*), C2(*). Switches are controlled through nodes v1 and v2. Preferably, the switches are field effect transistors. Bipolar transistors may be used in alternative embodiments. More preferably, the switches in a voltage divider are a P type MOSFET (i.e., PMOS transistor) to provide the multiplied voltage output and an N type MOSFET (i.e., NMOS transistor) through which current from voltage source VDDA is used to charge the capacitor C1(*), C2(*). The transistors and corresponding charging capacitor form an RC circuit whose time constant limits the phase clock frequency. For example, if the transistors are 100 ohms each and the capacitor is 10 picofarad, then the RC time constant (i.e., time to reach 63% of the final value) is about 1 nanosecond. The output signal from the PMOS transistors MP1(*), MP2(*) are tied together. To provide protection to the voltage multiplier circuitry, a protective diode (i.e., a P-N junction) may be added to each pair of coupled voltage dividers so as to permit charge flow in one direction only (i.e., the output). In an alternative embodiment, the PMOS transistors may be replaced with diodes.

The circuit of FIG. 1 alleviates the problems associated with high current draw voltage multipliers. Each phase of the voltage multiplier (multiplication M=2 in this version) operates as follows and is equivalent to a conventional single clock voltage multiplier. As phase clock PH1(*) rises to a HIGH level, the voltage at V1(*) rises from VDDA to approximately 2*VDDA. At this point, both transfer switches MP1(*) and MP2(*) are both off. Thus, there is no charge flowing to the output when the phase clocks PH1(*) and PH2(*) are both at a HIGH level (i.e., active level overlap time). Later, when PH2(*) falls to a LOW level, MN2(*) is turned ON and V2(*) discharges through MN2(*) which is controlled by V1(*). The charging capacitor C1(*) discharges some of its charge through MP1(*) onto output capacitor CLOAD during the time when V2(*) is at VDDA and MP1(*) is on. The speed at which the charge flows from C1(*) onto output capacitor CLOAD is inversely proportional to the size of CLOAD and the ON resistance of transfer switch MP1(*). In other words, the speed of charge flow is related to the RC time constant product of the ON resistance of the transfer switch and the capacitance of the output capacitor CLOAD. In the case where the ON resistance is 100 ohms and the capacitance of the output capacitor is 10 picofarads, the charge flow is 63% completed after one nanosecond and 86% completed after two nanoseconds. The phase clock PH2(*) then becomes a HIGH level and V2(*) rises to a HIGH level of approximately 2*VDDA. At this point, both transfer switches MP1(*) and MP2(*) are both off again and there is no charge flowing to the output and phase clocks PH1(*) and PH2(*) are both HIGH (active level overlap time). When the phase clock PH1(*) falls to a LOW level, MN1(*) is turned ON, and V1(*) discharges through MN1(*) which is controlled by V2(*). The charging capacitor C2(*) discharges some of its charge through MP2(*) onto output capacitor CLOAD during the time when V1(*) is at VDDA and MP2(*) is on. At this point, the process repeats. In order to supply enough current to the load during each clock cycle, the multiplier must transfer Q=I/T charge onto output capacitor CLOAD to sustain the voltage level VHH (I is the load current, T is the input clock period). The output capacitor CLOAD acts as a smoothing capacitor and a glitch filter. The multiplied voltage output may be further filtered; for example, by adding an inductor in the output path. Other output filter combinations may be used.

The operation of the multi-phase clocked voltage multiplier is described by referring to FIG. 1 again. As the phase clock PH1(1) rises to a HIGH level, the voltage at V1(1) rises from VDDA to approximately 2*VDDA. When the phase clock PH2(1) falls to a LOW level, MN2(1) is turned ON, and V2(1) discharges through MN2(1) which is controlled by V1(1). The charging capacitor C1(1) discharges some of its charge through transfer switch MP1(1) onto output capacitor CLOAD in the portion of time when V2(1) is at VDDA (a LOW level relative to VHH) and MP1(1) is on. The phase clock PH2(1) remains at a LOW level, allowing charge to continue to flow from C1(1) to CLOAD. The phase clock PHI(2) rises to a HIGH level. Thereafter, when the phase clock PH2(2) falls to a LOW level, MN2(2) is turned ON, and V2(2) discharges through MN2(2) which is controlled by V1(2). The charging capacitor C1(2) discharges some of its charge through MP1(2) onto output capacitor CLOAD during the time when V2(2) is at VDDA and MP1(2) is turned ON. The same operational steps are performed for all the phases. Thus, phase clock PH1(3) rises to a HIGH level, then phase clock PH2(3) falls to a LOW level, phase clock PH1(4) rises to a HIGH level, then phase clock PH2(4) falls to a LOW level, and so forth, until PH1(M) becomes HIGH, then phase clock PH2(M) falls to a LOW level. At any given time, either M or M-1 phases are simultaneously delivering charge to output capacitor CLOAD. The phase clock PH2(1) rises to a HIGH level and V2(1) rises to a HIGH level of approximately 2*VDDA. Although there is no charge being delivered from this phase of the multiplier, the output capacitor CLOAD is still receiving charge from phases 2 through M at this point. When the phase clock PH1(1) falls to a LOW level, MN1(1) is turned ON, and V1(1) discharges through MN1(1) which is controlled by V2(1). The charging capacitor C2(1) discharges some of its charge through MP2(1) onto the output capacitor CLOAD during the time when V1(1) is at VDDA and MP2(1) is on. Now each phase will continue this process; that is, PH2(2) rises to a HIGH level, then PH1(2) falls to a LOW level, PH2(3) rises to a HIGH level, then PH1(3) falls to a LOW level, and so forth, until PH2(M) rises to a HIGH level, then PH1(M) falls to a LOW level. At this point, the process repeats. It is obvious that there is no time when charge is not being delivered to the load by at least M-1 phases. This allows all the multiplying capacitors C1(*) and C2(*) to discharge and charge more completely.

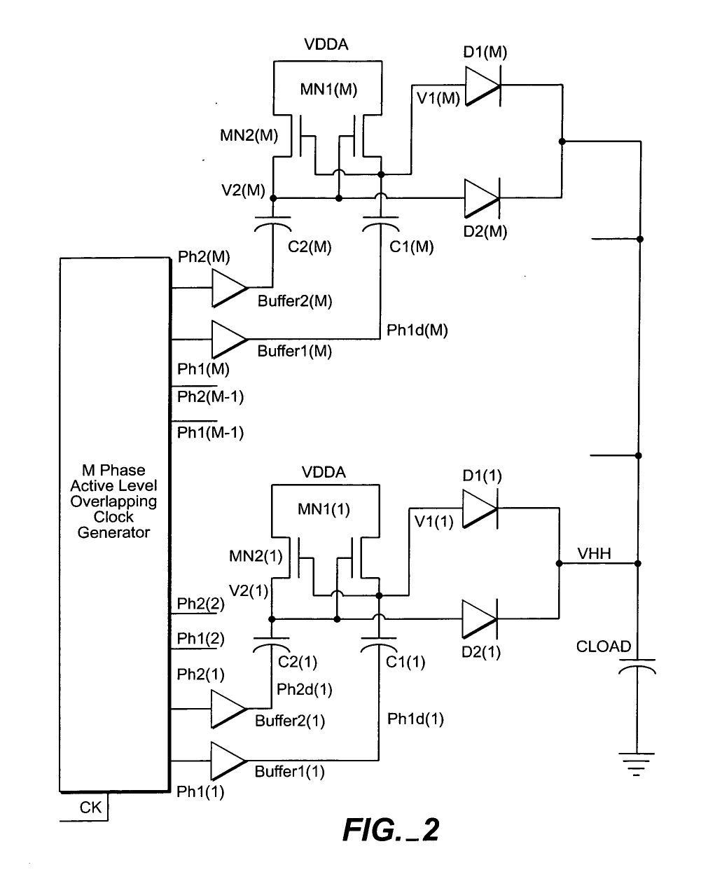

FIG. 2 illustrates an embodiment in which the PMOS transistors have been replaced by diodes.

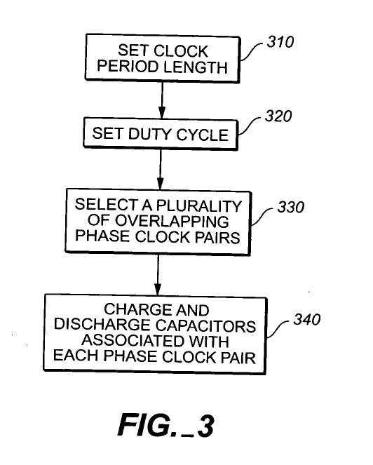

FIG. 3 illustrates an embodiment of a method of the present invention. The clock period of the basic phase clocks may be set through circuit design or be made adjustable through software inputs to a register 310. The basic phase clocks may be generated through software code. The duty cycle may be similarly set through hardware circuit design, through programmable registers, or through software code 320. A plurality of active level overlapping phase clock pairs are selected 330. If the selection is performed through software code, an operator may vary the number of phases to optimize performance. The selection may be hardwired through the circuit design. The method is used to charge and discharge capacitors associated with each phase clock pair 340.

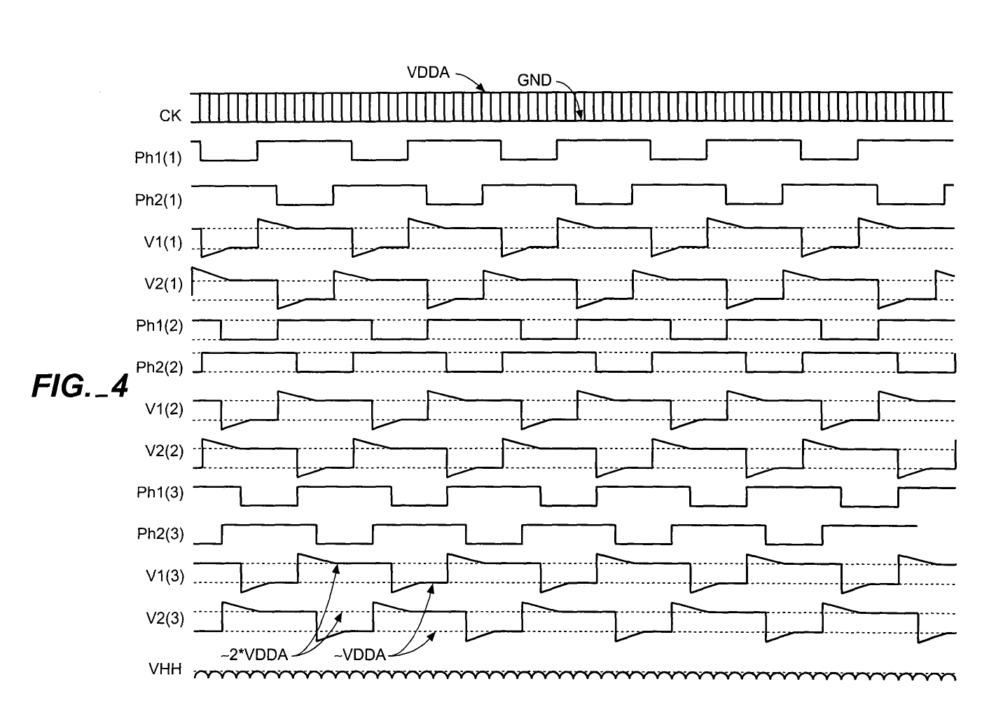

FIG. 4 illustrates the timing waveforms of the plurality of active level overlapping phase clocks. A ⅝ or 62.5% duty cycle is shown. Variations of the present invention allow for a different duty cycle such as ⅚, ⅔, 8/9, 9/16, and the like. In the present invention, each phase clock has a unique phase and all phase clocks are otherwise identical or essentially identical. The inactive portions of the two phase clocks in a pair never overlap.

Variations of the present invention may be implemented. For example, duty cycle processing may be accomplished through various Booleans expressions. Alternatively, flip flops may be used to provide the phase clocks. The supply voltage VDDA may be provided to the voltage multiplier through a current limiting resistor or through a capacitor. Varying the multiplication factor may be accomplished by various techniques. The multiplication factor may be a fraction, such as ⅔ or ½, or may be a number greater than one, such as 1.5, 3, or 4. Instead of a voltage divider formed of one NMOS transistor and one PMOS transistor tied together at their drains, two PMOS transistors may be arranged with one NMOS transistor. The transistors may also be scaled dimensionally so as to vary their effective resistance. There are many ways to make voltage multipliers, such as though a capacitor and a diode or through various combinations of capacitors, diodes, resistors, and transistors. The multi-phase technique may be used for all clocked multipliers to increase current capabilities, efficiency, etc.

It is believed that the present invention and many of its attendant advantages will be understood by the forgoing description. It is also believed that it will be apparent that various changes may be made in the form, construction and arrangement of the components thereof without departing from the scope and spirit of the invention or without sacrificing all of its material advantages, the form hereinbefore described being merely an explanatory embodiment thereof. It is the intention of the following claims to encompass and include such changes.

1. A high current, multi-phase voltage multiplier, comprising:
a multiple phase active level overlapping clock generator that generates multiple pairs of phase clocks, each of the pairs of phase clocks having an active portion and an inactive portion, the inactive portions of one of each of the pairs of phase clocks never overlapping; and
a plurality of voltage divider pairs, each of the voltage dividers formed by the junction of an input end switch and an output end switch, wherein each of the voltage dividers provides a switch control signal to the other of two voltage dividers in the pair, each of the voltage dividers being coupled to a charging capacitor, the charging capacitor being driven by the multiple phase active level overlapping clock generator.

2. The voltage multiplier of claim 1, wherein the clock generator provides a phase clock signal unique to each voltage divider.

3. The voltage multiplier of claim 2, wherein the phase clock signal is buffered between the clock generator and its corresponding charging capacitor.

4. The voltage multiplier of claim 1, wherein the input end switch and the output end switch of each of the plurality of voltage divider pairs are transistors.

5. The voltage multiplier of claim 4, wherein the transistors are bipolar transistors.

6. The voltage multiplier of claim 4, wherein the transistors are field effect transistors.

7. The voltage multiplier of claim 6, wherein the input end switch is an N type metal oxide semiconductor field effect transistor (NMOS FET) and the output end switch is a P type metal oxide semiconductor field effect transistor (PMOS FET).

8. The voltage multiplier of claim 7, wherein the NMOS and PMOS FETs of each of the voltage dividers are electrically connected together through their drain terminals.

9. The voltage multiplier of claim 8, wherein the output of the voltage multiplier is provided through the source terminals of the PMOS transistors of the plurality of voltage dividers.

10. The voltage multiplier of claim 9, wherein the source terminals of the PMOS transistors are tied together.

11. The voltage multiplier of claim 10, wherein the output of the voltage multiplier is smoothed by a smoothing capacitor that capacitively couples the output to circuit ground.

12. The voltage multiplier of claim 11, wherein the output of the voltage multiplier is filtered.

13. The voltage multiplier of claim 12, wherein the filter includes an inductor through which the output passes.

14. The voltage multiplier of claim 1, wherein the clock generator includes a counter that is clocked by a basic external clock.

15. The voltage multiplier of claim 14, wherein the clock generator includes a means for determining duty cycle.

16. The voltage multiplier of claim 15, wherein the clock generator includes tapped delay circuitry.

17. A method for multiplying a voltage in a circuit, comprising:
setting a length of a phase clock period;
setting a duty cycle of the phase clock period;
pairing overlapping phase clock signals from all of a plurality of phase clock signals; and
charging and discharging capacitors associated with each phase clock pair.

18. The method of claim 17, wherein the plurality of phase clock signals are four or more in number.

19. The method of claim 18, wherein each of the capacitors is involved in the operation of two voltage dividers.

20. The method of claim 19, wherein each of the capacitors controls switching of switches forming one of the two voltage dividers.

21. A high efficiency, high current multiphase voltage multiplier, comprising:
means for generating a plurality of unique phase clocks, the plurality of unique phase clocks being arranged into M pairs such that at least one phase clock of each pair is at an active HIGH level at any time, wherein M is an integer greater than 1;
means for multiplying a voltage; and
means for charging and discharging points of the means for multiplying a voltage.

22. The voltage multiplier of claim 21, wherein the means for multiplying a voltage doubles the voltage.

23. The voltage multiplier of claim 22, wherein the means for multiplying a voltage includes means for dividing a voltage.

24. The voltage multiplier of claim 23, wherein the means for dividing a voltage includes means for switching.
